(19) United States
(12) Patent Application Publication
(10) Pub. No.: US 2020/0172660 A1
(43) Pub. Date: Jun. 4, 2020

(54) NEW LIQUID HYDROCARBON COPOLYMERS COMPRISING TWO ALKOXYSILANE END GROUPS, AND PRODUCTION METHOD THEREOF

(71) Applicants: BOSTIK SA, Colombes (FR); CENTRE NATIONAL DE LA RECHERCHE SCIENTIFIQUE, Paris (FR); UNIVERSITE DE RENNES 1, Rennes Cedex (FR)

(72) Inventors: Guillaume MICHAUD, Compiegne (FR); Xiaolu MICHEL, Serris (FR); Frederic SIMON, Pont l'Eveque (FR); Stephane FOUQUAY, Mont Saint-Aignan (FR); Sophie GUILLAUME, Vitre (FR); Jean-Francois CARPENTIER, Acigne (FR)

(73) Assignees: BOSTIK SA, Colombes (FR); CENTRE NATIONAL DE LA RECHERCHE SCIENTIFIQUE, Paris (FR); UNIVERSITE DE RENNES 1, Rennes Cedex (FR)

(21) Appl. No.: 16/615,633

(22) PCT Filed: May 22, 2018
(86) PCT No.: PCT/EP2018/063365

§ 371 Date: Nov. 21, 2019

(30) Foreign Application Priority Data
May 24, 2017 (FR) 1754613

(51) Int. Cl. C08G 61/02; C09J 119/00; C08C 19/28

(52) U.S. Cl. CPC C08G 61/025; C09J 119/006; C08C 19/28; C08G 2261/1642; C08G 2261/726; C08G 2261/3327; C08G 2261/1644; C08G 2261/3324; C08G 2261/73; C08G 2261/122

(57) ABSTRACT

1) Hydrocarbon copolymer P comprising 2 alkoxysilane end groups F¹ and F² of formulae: —F¹: (R′O)₃₋ₜRₜSi—(CH₂)_{g}1- and F²: —(CH₂)_{d1}—SiRₜ(OR′)₃₋ₜ; or F¹: (R′O)₃₋ₜRₜSi—R″—O(O)C—(CH₂)_{g2}— and F²: —(CH₂)_{d2}—C(O)O—R″—SiRₜ(OR″)₃₋ₜ; wherein t is 0, 1 or 2; g1 and d1 are 1, 2 or 3; g2 and d2 are 0, 1, 2 or 3; R et R′ represent a C₁-C₄ alkyl; R″ is a C₁-C₄ alkylene radical; the main chain comprising motifs (I) and (II) in which R⁰ is in particular the methyl radical; and the number average molecular mass Mn thereof being between 400 and 100,000 g/mol. 2) Method for producing said copolymer, comprising: (i) a step of heating a statistical bipolymer A selected from a poly(butadiene-isoprene), a poly(butadiene-myrcene) and a poly(butadiene-farnesene); and subsequently (ii) a step of heating the formed product, in the presence of a chain transfer agent of formula (C). 3) Adhesive composition comprising said copolymer.

The present invention relates to hydrocarbon-based copolymers comprising two alkoxysilane end groups, which are liquid at room temperature. The invention also relates to the preparation and the use of said copolymers.

Modified silane polymers (MS polymers) are liquid hydrocarbon-based polymers containing two alkoxysilane end groups, which are known in the field of adhesives. They are used for the assembly of a wide variety of objects (or substrates) via adhesive bonding. Thus, compositions based on MS polymers are applied, in combination with a catalyst, in the form of an adhesive layer, to at least one of two surfaces belonging to two substrates to be assembled and intended to be brought into contact with each other in order to assemble them. The MS polymer reacts by crosslinking in the presence of water (coming from the surrounding medium and/or from the substrates), which results in the formation of a cohesive adhesive seal ensuring the sturdiness of the assembly of these two substrates. This adhesive seal mainly consists of the MS polymer crosslinked to give a three-dimensional network formed by the polymer chains connected together by bonds of siloxane type. The crosslinking may take place before or after the two substrates are brought into contact and the application, where appropriate, of pressure at their faying surface.

However, MS polymers generally have to be used in the form of adhesive compositions comprising other constituents, for instance tackifying resins, one or more additives with a reinforcing effect, for instance a mineral filler, or else one or more additives aimed at improving the pot life (that is to say, the time at the end of which the crosslinking can be regarded as complete) or other characteristics, such as the rheology or the mechanical performance (elongation, modulus, etc.).

International patent application WO 2016/110653 from Bostik describes hydrocarbon-based polymers comprising two alkoxysilane end groups, which are obtained via a ring-opening metathesis polymerization reaction, which uses, besides a catalyst and a transfer agent, a cycloolefin (notably a cyclooctene) and norbornene or one of the derivatives thereof. The polymers obtained are generally viscous liquids at room temperature.

It is convenient for the adhesives industry to have available compositions which can be applied at room temperature by the end user and which can also be manufactured industrially, also at room temperature, by simple mixing of the silyl polymer and of the additional constituents mentioned above. It is thus particularly advantageous to have available, for this purpose, hydrocarbon-based polymers bearing alkoxysilane end groups, which are themselves liquid at room temperature.

However, the production, in WO 2016/110653, of liquid hydrocarbon-based polymers requires the use of cyclooctene or of substituted cyclooctene derivatives. Now, these products correspond to starting materials that are not industrially accessible or are only accessible with difficulty.

Furthermore, the process for preparing the hydrocarbon-based polymers that are the subject of WO 2016/110653 is highly exothermic, which greatly complicates the execution of a process for manufacturing said polymers industrially.

The aim of the present invention is to propose novel polymers bearing two alkoxysilane end groups, which overcome these drawbacks.

Another aim of the present invention is to propose polymers that are liquid at room temperature, which can lead, after crosslinking, to the formation of an adhesive seal having improved mechanical properties.

Another aim of the present invention is to propose liquid alkoxysilane-terminated polymers, which are notably of lower viscosity at room temperature, and which may also be manufactured via a process which uses starting materials that are widely industrially available.

Another aim of the present invention is to propose such polymers, which can also be manufactured industrially via a process whose exothermicity is easier to control.

It has now been found that these aims may be achieved, in total or in part, by means of the hydrocarbon-based polymer described below.

Thus, the present invention relates to a hydrocarbon-based copolymer P comprising two alkoxysilane end groups F¹ and F² connected, respectively, to each of the two ends of the main chain, having the formulae:

—F¹: (R′O)₃₋ₜRₜSi—(CH₂)_{g1}—

and F²: —(CH₂)_{d1}—SiRₜ(OR′)₃₋ₜ; or else

—F¹: (R′O)₃₋ₜRₜSi—R″—O(O)C—(CH₂)_{g2}—

and F²: —(CH₂)_{d2}—C(O)O—R″—SiRₜ(OR′)₃₋ₜ;

in which:

t is an integer equal to 0, 1 or 2;

g1 and d1, which may be identical or different, represent an integer equal to 1, 2 or 3;

g2 and d2, which may be identical or different, represent an integer equal to 0, 1, 2 or 3;

R and R′, which may be identical or different, represent an alkyl radical comprising from 1 to 4 carbon atoms;

R″ is an alkylene radical comprising from 1 to 4 carbon atoms;

characterized in that the main chain of the copolymer P comprises:
a unit (I) of formula (I) repeated p times, p being an integer other than 0:

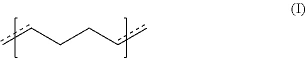

a unit (II) of formula (II) repeated n times, n being an integer other than 0:

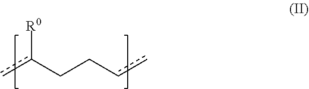

in which R⁰ represents a methyl radical or one of the three radicals having the following formula:

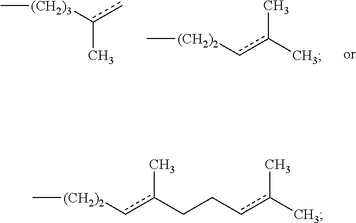

and, optionally, a unit (Ill) of formula (Ill) repeated m times, m being an integer greater than or equal to 0:

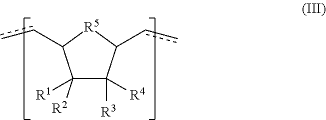

in which:

R¹, R², R³ and R⁴, which may be identical or different, represent:
a hydrogen or halogen atom; or
a radical comprising from 1 to 22 carbon atoms which is chosen from alkyl, alkenyl, alkoxycarbonyl, alkenyloxycarbonyl, alkylcarbonyloxy, alkenylcarbonyloxy and alkylcarbonyloxyalkyl, it being possible for the hydrocarbon-based chain of said radical to be optionally interrupted with at least one oxygen atom or one sulfur atom; in addition:
at least one of the groups R¹ to R⁴ can form, with at least one other of the groups R¹ to R⁴ and with the carbon atom or atoms to which said groups are linked, a 3- to 10-membered, optionally substituted, saturated or unsaturated hydrocarbon-based ring or heterocycle; and
at least one of the pairs (R¹, R²) and (R³, R⁴) can form, with the carbon atom to which said pair is linked, a group of two carbon atoms linked by a double bond: C═C, the other carbon atom of which bears two substituents chosen from a hydrogen atom and a C₁-C₄ alkyl radical; and
the carbon atom bearing one of the groups of the pair (R¹, R²) may be linked to the carbon atom bearing one of the groups of the pair (R³, R⁴) by a double bond, it being understood that, in accordance with the valency rules, only one of the groups of each of these two pairs is then present;

R⁵ represents:
an oxygen or sulfur atom, or
a divalent radical —CH₂—, —C(═O)— or —NR⁶— in which R⁶ is an alkyl or alkenyl radical comprising from 1 to 22 carbon atoms;
it also being pointed out that:
the bond [symbol] represents a single bond or a double bond;
F¹ and F² are directly linked to two units (I); and
n, p and m are such that the number-average molecular mass Mn of the copolymer P is within a range extending from 400 to 100 000 g/mol and its polydispersity index is within a range extending from 1.5 to 3.0.

The various groups, radicals and letters which are included in formulae F¹ and F² and in the definition of the main chain of the copolymer P retain the same meaning throughout the present text, unless otherwise indicated.

The units (I), (II) and, optionally, (III) are divalent radicals that are randomly distributed in the main chain of the copolymer P, with the exception of two units (I) which are directly connected to F¹ and F². The copolymer P is thus a statistical copolymer.

The main chain of the copolymer P thus comprises two or three repeating units:
a first repeating unit (I) repeated p times of formula (I),
a second repeating unit (II) repeated n times of formula (II), and
a third repeating unit (III) repeated m times of formula (III), which is optional;
such that the copolymer P may be a bipolymer (presence of the two repeating units (I) and (II)) or a terpolymer (presence of the three repeating units (I), (II) and (III)).

As is seen above, the end groups F¹ and F² are generally symmetrical relative to the main chain, i.e. they correspond substantially, with the exception of the indices g1 and g2, and d1 and d2.

The term “heterocycle” means a hydrocarbon-based ring which may comprise an atom other than carbon in the chain of the ring, for instance oxygen, sulfur or nitrogen atoms.

The term “end group” means a group located at one of the two ends of the main chain of the polymer.

The term “copolymer” means a polymer derived from the copolymerization of at least two comonomers, i.e. of two chemically different monomers. The main chain of a copolymer comprises at least two chemically different repeating units.

The term “terpolymer” means a copolymer derived from the copolymerization of three comonomers, and the main chain of which essentially consists of three different repeating units.

The term “bipolymer” denotes a copolymer derived from the copolymerization of two comonomers, and the main chain of which essentially consists of two different repeating units.

The polydispersity index (also known as the PDI) is defined as the ratio Mw/Mn, i.e. the ratio of the weight-average molecular mass to the number-average molecular mass of the polymer.

In the present text, the two average molecular masses Mn and Mw are measured by size exclusion chromatography (or SEC), which is also denoted by the term “gel permeation chromatography” (or GPC). The calibration performed is usually a PEG (PolyEthylene Glycol) or PS (PolyStyrene), preferably PS, calibration.

If t=0, then there is no group R in the groups F¹ and F²: (R′O)₃₋ₜRₜSi— becomes (R′O)₃Si—.

If g2=0 or d2=0, then there is no —(CH₂)— radical in the groups F¹ and F². In other words, the radical: —(CH₂)_{g2}— or —(CH₂)_{d2}— is replaced with a single bond.

The copolymer P according to the invention is particularly homogeneous and heat-stable. It is advantageously, at room temperature, in the form of a viscous liquid whose Brookfield viscosity at 23° C. is between 1 mPa·s and 150 Pa·s, preferably between 1 and 50 Pa·s.

The copolymer P may form, after a crosslinking reaction in the presence of water and of a catalyst, an adhesive seal resulting from the formation of siloxane bonds Si—O—Si between the polymer chains.

The water used in the crosslinking reaction is the water from the ambient medium and/or water provided by at least one substrate, generally atmospheric humidity, corresponding, for example, to a relative humidity of the air (also known as the degree of hygrometry) usually within a range from 25% to 65%.

The adhesive seal thus formed has high cohesive values, in particular of greater than 2 MPa. Such cohesive values allow said polymer to be used as adhesive, for example as leaktightness seal on an ordinary support (concrete, glass, marble), in the building industry, or alternatively for the bonding of glazings in the motor vehicle and naval industries.

This ability which the polymers of formula (I) according to the invention have to crosslink in the presence of moisture is thus particularly advantageous.

The copolymer P is preferably packaged and stored in the absence of moisture.

According to a preferred variant, the main chain of the copolymer P essentially consists of the repeating unit (I) of formula (I), of the repeating unit (II) of formula (II) and, optionally, of the repeating unit (III) of formula (III). Thus, the number of units (I), (II) and, optionally, (Ill) advantageously represents at least 90% of the total number of constituent units of the main chain of the copolymer P, and even more advantageously at least 95%.

According to a preferred variant, the relative proportion of units of formula (I) and of units of formula (II) present in the main chain of the copolymer P corresponds to an excess of units of formula (I). More particularly, the number p of units (I) and the number n of units (II) are such that:
p/(n+p) is between 45% and 95%, and
n/(n+p) is between 5% and 55%.

The latter parameters may be determined analytically by ¹H and ¹³C NMR spectroscopy.

According to a first embodiment, which is more preferred, of the copolymer P according to the invention, all the bonds [symbol] that are represented in formulae (I), (II) and, optionally, (III) and also in the formulae giving the meaning of R⁰ are carbon-carbon double bonds.

According to this first embodiment, the main chain of the copolymer P is thus such that:
the unit (I) also has the formula (I′):

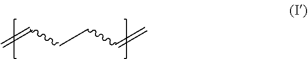

the unit (II) also has the formula (II′):

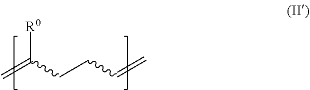

in which R⁰ represents a methyl radical or one of the three radicals having the following formula:

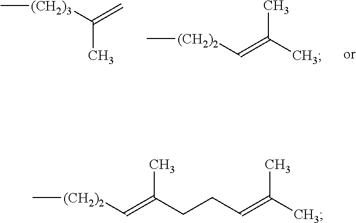

and, optionally, the unit (III) also has the formula (III′):

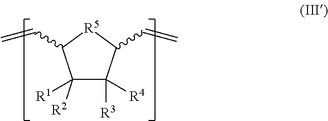

it being pointed out that, in the above formulae, the [symbol] bond is a single bond geometrically oriented on one side or the other relative to the double bond (cis or trans).

The corresponding units of the main chain of the copolymer P are then themselves connected via a carbon-carbon double bond.

According to a most particularly preferred variant of this first embodiment of the invention, the main chain of the copolymer P is such that:
on the p units of formula (I′), p″ also correspond to formula (I″), p″ being an integer other than 0, less than p and such that p″/p is greater than 0.8:

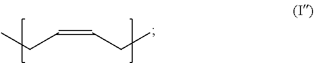

and
on the n units of formula (II′), n″ also correspond to formula (II″), n″ being an integer other than 0, less than n and such that n″/n is greater than 0.9:

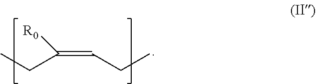

In accordance with this embodiment, at least 80% of the units of formula (I′) are of cis configuration, represented by formula (I″), and at least 90% of the units of formula (II′) are also of cis configuration, represented by formula (II″). The corresponding percentages may be determined by ¹H and ¹³C NMR.

According to another variant of this first embodiment, m is equal to 0 and the main chain of P does not comprise any units of formula (III′).

According to a second embodiment of the copolymer P according to the invention, all the bonds [symbol] that are represented in formulae (I), (II) and, optionally, (III) and also in the formulae giving the meaning of R⁰ are carbon-carbon single bonds.

According to this second embodiment, the main chain of the copolymer P is thus such that:
the unit (I) also has the formula (I^{H}):

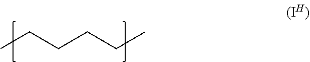

the unit (II) also has the formula (II^{H}):

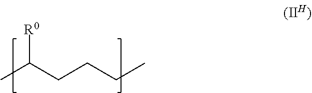

in which R⁰ represents a methyl radical or one of the three radicals having the following formula:

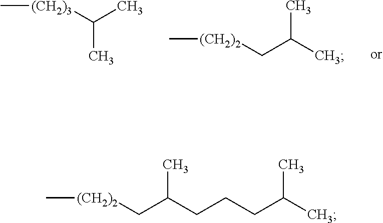

and, optionally, the unit (III) has the formula (III^{H}):

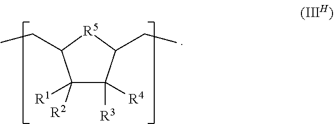

The copolymer P according to this second embodiment is derived, for example, from the hydrogenation of the copolymer P according to the first embodiment described above.

According to an even more preferred variant of each of these two embodiments, the radical R⁰ of the unit (II) represents a methyl radical.

As regards the alkoxysilane end groups of the copolymer according to the invention, when F¹ is (R′O)₃₋ₜRₜSi—(CH₂)_{g1}— and F² is —(CH₂)_{d1}—SiRₜ(OR′)₃₋ₜ, then, preferably, g1=1 or d1=1 and, even more preferably: g1=d1=1. In this latter case, F¹ and F² are even more preferentially each: —CH₂—Si(OCH₃)₃.

When (case known as the “diester route”), F¹ is:

(R′O)₃₋ₜRₜSi—R″—O(O)C—(CH₂)_{g2}—

and F² is: —(CH₂)_{d2}—C(O)O—R″—SiRₜ(OR′)₃₋ₜ, then, preferably, g2=0 or d2=0 and, even more preferably: g2=d2=0. In this latter case, particularly advantageously, F¹ and F² are each: —C(O)O—(CH₂)₃—Si(OCH₃)₃.

The invention also relates to a process for preparing the hydrocarbon-based copolymer P as defined previously, said process comprising:

(i) a step of heating at a temperature ranging from 30° C. to 80° C.:
(a) of a statistical bipolymer A chosen from a poly(butadiene-isoprene), a poly(butadiene-myrcene) and a poly(butadiene-farnesene); and
(b) optionally a compound B of formula (B):

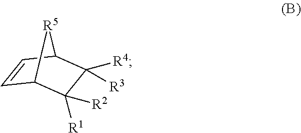

and then

(ii) a step of heating the product formed in step (i) to a temperature in an interval from 20 to 60° C., in the presence of a chain-transfer agent (also referred to as CTA) of formula (C):

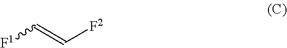

in which:
F¹ and F² are as defined previously;
the [symbol] bond is a single bond geometrically oriented on one side or the other relative to the double bond (cis or trans);
it also being pointed out that each of the steps (i) and (ii) is performed in the presence of a metathesis catalyst and of a solvent.

Step (i):

Step (i) involves a depolymerization reaction of the bipolymer A and intramolecular cyclization, which leads to the formation of one (or more) macrocyclic cooligomer O comprising:
the unit of formula (I′) repeated p′⁰ times, p′⁰ being an integer other than 0;
the unit of formula (II′) repeated n′⁰ times, n′⁰ being an integer other than 0;
and, optionally, the unit of formula (III′) repeated m′⁰ times, m′⁰ being an integer greater than or equal to 0;

it being pointed out that p′⁰, n′⁰ and m′⁰ are such that the number-average molecular mass Mn of the cyclic cooligomer(s) O is in a range extending from 162 to 5000 g/mol, preferably from 1000 to 3000 g/mol.

The formation and the structure of the macrocyclic cooligomer(s) O may be characterized by size exclusion chromatography (or SEC) and mass spectrometry techniques. The distribution in the macrocycle of the units of formulae (I′), (II′) and optionally (III′) is statistical.

A preferred temperature range for the heating of the bipolymer A and, optionally, of compound B, according to step (i) ranges from 30° C. to 60° C.

The corresponding heating time is adapted to obtain a yield close to 100% relative to the molar amount of bipolymer A used, and also that of the other reagents present. A time ranging from 1 hour to 8 hours, preferably from 1 to 3 hours, is generally suitable.

Bipolymer A:

The bipolymer A is a copolymer which essentially consists of two monomers and is chosen from a poly(butadiene-isoprene), a poly(butadiene-myrcene) and a poly(butadiene-farnesene).

According to a first variant, which is most particularly preferred, of the process according to the invention, the bipolymer A used in step (i) is a poly-(butadiene-isoprene). In this case, the product advantageously obtained on conclusion of step (ii) is a hydrocarbon-based copolymer P according to the invention whose main chain comprises:
the repeating unit of formula (I′) and
the repeating unit of formula (II′) in which R⁰ represents a methyl radical.

The poly(butadiene-isoprene) polymers are copolymers which constitute an industrially advantageous starting material, notably on account of their availability and of their properties in terms of industrial hygiene. The poly(butadiene-isoprene) polymers are generally obtained via various processes of polymerization:
of 1,3-butadiene of formula: H₂C═CH—CH═CH₂, and
2-methylbuta-1,3-diene (or isoprene), of formula:

H₂C═C(CH₃)—CH═CH₂.

The polymerization of 1,3-butadiene may be performed according to a trans-1,4 addition or a cis-1,4 addition, resulting in a repeating unit in the copolymer chain (designated, respectively, by trans-1,4 and cis-1,4 butadiene unit), which is in the form of the two geometrical isomers having the respective formulae:

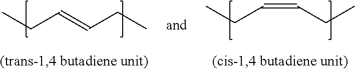

The cis-1,4 butadiene unit is identical to the unit of formula (I″) defined previously.

The polymerization of 1,3-butadiene may also be performed according to a 1,2-addition, resulting in a repeating unit in the copolymer chain (designated by vinyl-1,2 butadiene unit) which has the formula:

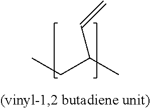

Thus, the poly(butadiene-isoprene) generally comprises in its chain the above three repeating units, designated hereinbelow generically by “butadiene-based units”.

Similarly, the polymerization of isoprene may be performed according to a trans-1,4 addition or a cis-1,4 addition, resulting in a repeating unit in the copolymer chain (designated, respectively, by trans-1,4 and cis-1,4 isoprene unit), which is in the form of the two geometrical isomers having the respective formulae:

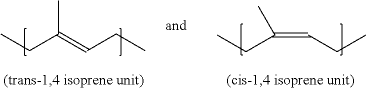

The cis-1,4 isoprene unit is identical to the unit of formula (II″) in which R⁰ is a methyl, as defined previously.

The polymerization of isoprene may also be performed according to a 1,2-addition, resulting in a repeating unit in the copolymer chain (designated by vinyl-1,2 isoprene unit) which has the formula:

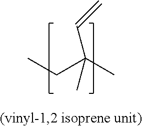

The polymerization of isoprene may, finally, be performed according to a 3,4-addition, resulting in a repeating unit in the copolymer chain (designated by vinyl-3,4 isoprene unit) which has the formula:

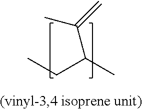

Thus, the poly(butadiene-isoprene) generally comprises in its chain the above four repeating units, designated hereinbelow generically by “isoprene-based units”.

The poly(butadiene-isoprene) used in step (i) may have a number-average molecular mass (Mn) ranging from 3000 to 100 000 g/mol, preferably from 3000 to 50 000 g/mol, and a glass transition temperature (Tg) ranging from −110 to −60° C.

It preferably comprises from 45% to 95% by number of butadiene-based units and from 5% to 55% by number of isoprene-based units, said percentages being expressed on the basis of the total number of constituent units of the poly(butadiene-isoprene) chain.

Preferably, the chain of the poly(butadiene-isoprene) used in step (i) comprises:
less than 5% by number of vinyl-1,2 butadiene units on the basis of the number of butadiene-based units, and
less than 5% of the total number of vinyl-1,2 isoprene units and of vinyl-3,4 isoprene units on the basis of the number of isoprene-based units.

Even more preferentially, this twofold limit greater than 5 mol % is lowered to 2%.

According to another variant, which is most particularly preferred, the chain of the poly(butadiene-isoprene) used in step (i) comprises:
at least 80% by number of cis-1,4 butadiene units on the basis of the number of butadiene-based units, and
at least 90% by number of cis-1,4 isoprene units on the basis of the number of isoprene-based units.

In accordance with this last variant, such a poly(butadiene-isoprene), which is liquid at room temperature, is often termed as having “a high content of cis-1,4 butadiene and cis-1,4 isoprene units” and is also referred to by the term “high cis poly(butadiene-isoprene)”. On conclusion of step (ii), the preferred variant of the copolymer P corresponding to the presence of the units of formulae (I″) and (II″), as defined previously, is then advantageously obtained.

The percentage by number of vinyl-1,2 butadiene, vinyl-1,2 isoprene, vinyl-3,4 isoprene, cis-1,4 butadiene and cis-1,4 isoprene units, defined above, may be determined by ¹H and ¹³C NMR.

An example of such a poly(butadiene-isoprene) that may be mentioned is Kuraprene® LIR-390, which is commercially available from the company Kuraray.

This liquid poly(butadiene-isoprene) has a number-average molecular mass (Mn) equal to 48 000 g/mol. It comprises 92% by number of butadiene-based units and 8% by number of isoprene-based units, said percentages being expressed on the basis of the total number of constituent butadiene-based and isoprene-based units in the chain.

It also comprises:
on the basis of the number of butadiene-based units, about 1% by number of vinyl-1,2 butadiene units, and
on the basis of the number of isoprene-based units, about 1% by number of vinyl-1,2 isoprene units and less than 1% by number of vinyl-3,4 isoprene units.

It finally comprises:
about 85% by number of cis-1,4 butadiene units on the basis of the number of butadiene-based units, and
about 98% by number of cis-1,4 isoprene units on the basis of the number of isoprene-based units.

Another example of a poly(butadiene-isoprene) that may be mentioned is Kuraprene® LIR-340, which is also commercially available from the company Kuraray.

This poly(butadiene-isoprene) has a number-average molecular mass (Mn) equal to 34 000 g/mol. It comprises 46% by number of butadiene-based units and 54% by number of isoprene-based units, said percentages being expressed on the basis of the total number of constituent units in the chain. It moreover has the same characteristics as those indicated previously for Kuraprene® LIR-390.

According to a second variant of the process according to the invention, the bipolymer A is either a poly(butadiene-myrcene) or a poly(butadiene-farnesene).

Myrcene is a natural organic compound belonging to the chemical family of monoterpenes and is an important intermediate in the fragrance industry. It is produced semi-synthetically from plants of the genus Myrcia. It is in the form of two geometrical isomers:
α-myrcene, having the structural formula:

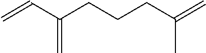

β-myrcene, having the structural formula:

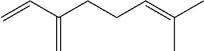

Farnesene or β-farnesene is a natural isoprenoid compound which may be chemically synthesized by oligomerization of isoprene or by dehydration of neridol. It is mainly used as a fragrance or intermediate and corresponds to the structural formula:

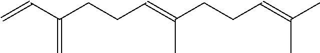

Reference is made to patent application EP 2810963 for the processes for preparing copoly(butadiene-myrcene) and copoly(butadiene-farnesene).

In this second variant, the product obtained on conclusion of step (ii) is a hydrocarbon-based copolymer P according to the invention whose main chain comprises:
the repeating unit of formula (I′) and
the repeating unit of formula (II′) in which R⁰ represents:
   the radical of formula:

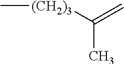

corresponding to α-myrcene;

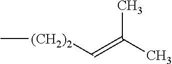

corresponding to β-myrcene; or

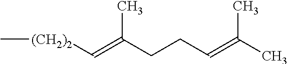

corresponding to β-farnesene.

Compound of Formula (B):

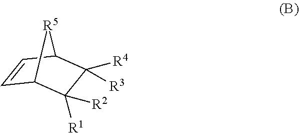

The use in step (i) of the compound of formula (B) advantageously leads to the production of copolymers P according to the invention whose main chain comprises the additional unit of formula (III′), as defined previously.

The compound of formula (B) generally comprises from 6 to 30 and preferably from 6 to 22 carbon atoms.

Preferably:
R¹, R², R³ and R⁴ represent a hydrogen atom or an alkyl or alkoxycarbonyl radical comprising from 1 to 14 and even more preferentially from 1 to 8 carbon atoms;
the radical R⁶ included in the group —NR⁶, which is one of the meanings of R⁵, is a linear radical comprising from 1 to 14 carbon atoms.

According to an even more preferred variant:
at most one of the groups taken from (R¹, R², R² and R⁴) is a C₁-C₈ alkoxycarbonyl radical and all the others represent a hydrogen atom; and/or
R⁵ represents a —CH₂— radical or an oxygen atom.

The compound of formula (B) is notably chosen from:
norbornene, of the following formula:

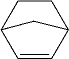

norbornadiene, of the following formula:

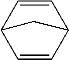

dicyclopentadiene, of the following formula:

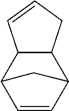

7-oxanorbornene, of the following formula:

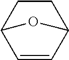

7-oxanorbornadiene, of the following formula:

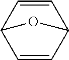

5-ethylidene-2-norbornene, of the following formula:

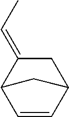

or 5-norbornene-2-methyl acetate, of the following formula:

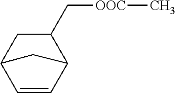

The compound of formula (B) may also be chosen from the compounds having the following formulae:

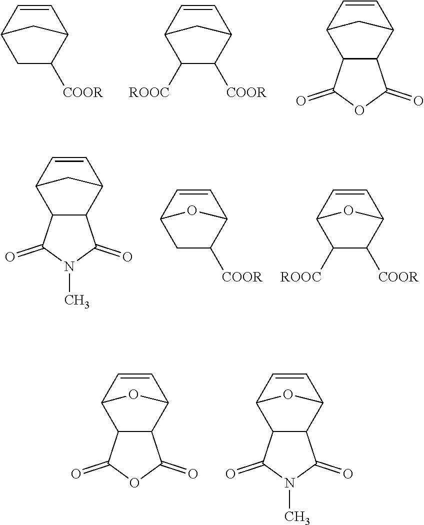

in which R is an alkyl radical comprising from 1 to 22 carbon atoms, preferably from 1 to 14 carbon atoms.

The compound of formula (B) may also be chosen from the group formed by the addition products (or adducts) resulting from the Diels-Alder reaction using cyclopentadiene or furan as starting material, and also norbornene-based compounds, such as the branched norbornenes as described in WO 2001/04173 (such as: norbornene isobornyl carboxylate, norbornene phenyl carboxylate, norbornene ethylhexyl carboxylate, norbornene phenoxyethyl carboxylate and alkyl norbornene dicarboximide, the alkyl usually including from 3 to 8 carbon atoms), and the substituted norbornenes as described in WO 2011/038057 (norbornene dicarboxylic anhydrides and optionally 7-oxanorbornene dicarboxylic anhydrides).

Among the various compounds mentioned of formula (B), the ones most particularly preferred are norbornene and dicyclopentadiene.

Step (ii):

The macrocyclic cooligomers O corresponding to the product formed in step (i) are polymerized by heating to a temperature in an interval from 20 to 60° C., in the presence of a chain-transfer agent (also referred to as CTA) of formula (C):

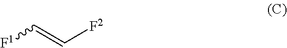

in which:
F¹ and F² are as defined previously;
the [symbol] bond is a single bond geometrically oriented on one side or the other relative to the double bond (cis or trans).

Without being bound by any reaction mechanism, it is estimated that this step involves a polymerization by opening of the macrocycles O and a cross-metathesis with the CTA.

This step (ii) advantageously has low exothermicity, and as such the industrial implementation of the process according to the invention does not pose any temperature control difficulties.

The molar amount of CTA to be introduced into the present step (ii) is linked to the molar amount of bipolymer A and, optionally, to the molar amount of compound B introduced into step (i).

These molar amounts are such that the ratio r which is equal to the ratio of the number of moles of said CTA:
to the number N_{(A)} of moles of the bipolymer A, in the case where said bipolymer A is the only reagent used in step (i), or
to the sum of N_{(A)} and of the number of moles N_{(B)} of the compound of formula (B), in the case where the compound of formula (B) is also used in step (i),

is in an interval ranging from 0.0010 to 1.0.

Thus, when, in accordance with a preferred variant of the process according to the invention, the bipolymer A is a poly(butadiene-isoprene), said ratio r is equal to the ratio of the number of moles of the CTA:
to the number N_{(A)} of moles of said poly(butadiene-isoprene), in the case where said poly(butadiene-isoprene) is the only reagent used in step (i), or
to the sum of N_{(A)} and of the number of moles N_{(B)} of the compound of formula (B), in the case where the compound of formula (B) is also used in step (i).

Even more preferably, the ratio r defined above is in an interval ranging from 0.0020 to 0.3.

According to a first embodiment, the CTA has the formula (C1) below:

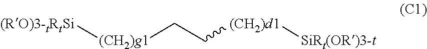

in which R, R′, t, g1, d1 and [symbol] have the meanings given previously.

This compound may be manufactured according to the process described in WO 01/83097 by cross metathesis of monounsaturated compounds H₂C═CH—(CH₂)ₚ—SiRₜ(OR′)₃₋ₜ.

According to this embodiment, preferably, g1=1 or d1=1 and, even more preferably: g1=d1=1.

According to an even more advantageous variant, t is equal to 0 and R′ is a methyl. In this latter case, F¹ and F² are each: —CH₂—Si(OCH₃)₃ and the compound of formula (C1) becomes:

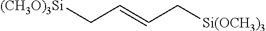

This compound, which is trans-1,4-bis(trimethoxysilyl)but-2-ene is referred to in the rest of the present text as CTA¹.

According to a second embodiment (known as the “ester route”), the CTA of formula (C) has the formula (C2) below:

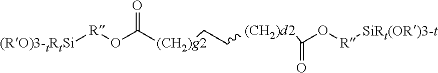

in which R, R′, R″, t, g2, d2 and [symbol] have the meanings given previously.

This compound may be synthesized by esterification of an acid dichloride of the type CIC(═O)(CH₂)_{g2}CH═CH(CH₂)_{d2}C(═O)Cl (which is itself prepared from the corresponding commercial dicarboxylic acid) with two moles of hydroxysilane.

According to this embodiment, preferably, g2=0 or d2=0 and, even more preferably: g2=d2=0.

According to an even more advantageous variant, t is equal to 0 and R″ is an n-propylene radical: —(CH₂)₃—.

In this latter case, F¹ and F² are each: —CO—O—(CH₂)₃—Si(OCH₃)₃ and the compound of formula (C2) becomes:

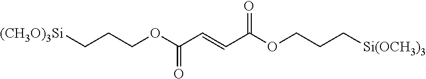

This compound, which is bis(propyltrimethoxysilyl) fumarate, is referred to in the rest of the present text as CTA².

According to a most particularly preferred variant of the invention, the CTA of formula (C) is chosen from the group formed by trans-1,4-bis(trimethoxysilyl)but-2-ene (CTA¹) and bis(propyltrimethoxysilyl) fumarate (CTA²).

Metathesis Catalyst and Solvent Used in Steps (i) and (ii):

Steps (i) and (ii) of the process according to the invention each involve a metathesis catalyst and a solvent which may be identical or different, and preferably identical in each of these two steps.

The metathesis catalyst is preferably a ruthenium-based catalyst and even more preferably a Grubbs catalyst.

Such a catalyst is generally a commercial product.

The metathesis catalyst is generally a transition metal catalyst, notably including a ruthenium-based catalyst, generally in the form of ruthenium complex(es), such as a ruthenium-carbene complex.

According to the invention, the term “Grubbs catalyst” generally means a 1^{st} or 2^{nd} generation Grubbs catalyst, but also any other catalyst of Grubbs type (of ruthenium-carbene type) or Hoveyda-Grubbs type accessible to a person skilled in the art, for instance the substituted Grubbs catalysts described in patent U.S. Pat. No. 5,849,851.

A 1^{st} generation Grubbs catalyst is generally of formula (G1):

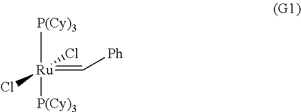

in which Ph is phenyl, Cy is cyclohexyl and the group P(Cy)₃ is a tricyclohexylphosphine group.
The IUPAC name of this compound is: benzylidenebis(tricyclohexylphosphine)dichlororuthenium (of CAS number 172222-30-9). Such a catalyst is notably available from the company Aldrich.

A 2^{nd} generation (or G2) Grubbs catalyst that is preferred is generally of formula (G2):

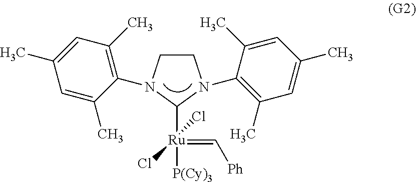

in which Ph is phenyl and Cy is cyclohexyl.
The IUPAC name of the second generation of this catalyst is benzylidene[1,3-bis(2,4,6-trimethylphenyl)-2-imidazolidinylidene]dichloro(tricyclohexylphosphine)ruthenium (of CAS number 246047-72-3). This catalyst is also available from the company Aldrich.

The solvent is generally chosen from the group formed by the aqueous or organic solvents typically used in polymerization reactions and which are inert under the polymerization conditions, such as aromatic hydrocarbons, chlorinated hydrocarbons, ethers, aliphatic hydrocarbons, alcohols, water or mixtures thereof.

A preferred solvent is chosen from the group formed by benzene, toluene, para-xylene, methylene chloride (or dichloromethane), 1,2-dichloroethane, dichlorobenzene, chlorobenzene, tetrahydrofuran, diethyl ether, pentane, hexane, heptane, a mixture of liquid isoparaffins (for example Isopar®), methanol, ethanol, water or mixtures thereof.

Even more preferably, the solvent is chosen from the group formed by benzene, toluene, para-xylene, methylene chloride, 1,2-dichloroethane, dichlorobenzene, chlorobenzene, tetrahydrofuran, diethyl ether, pentane, hexane, heptane, methanol, ethanol or mixtures thereof.

Even more particularly preferably, the solvent is dichloromethane, 1,2-dichloroethane, toluene, heptane or a mixture of toluene and 1,2-dichloroethane.

The main chain of the hydrocarbon-based copolymer P according to the invention that is obtained directly on conclusion of steps (i) and (ii) is unsaturated, and, more precisely, comprises—in accordance with the first embodiment described previously for said copolymer—a unit (I) of formula (I′) repeated p′ times, a unit (II) of formula (II′) repeated n′ times and, optionally, a unit (III) of formula (III′) repeated m′ times.

The process for preparing the hydrocarbon-based copolymer P that has just been described may also comprise, besides steps (i) and (ii), an additional step of hydrogenation of the double bonds.

This step is generally performed by catalytic hydrogenation, usually under hydrogen pressure and in the presence of a hydrogenation catalyst, such as a catalyst of palladium supported on carbon (Pd/C). It makes it possible more particularly to obtain for the hydrocarbon-based copolymer P—in accordance with the second embodiment described previously for said copolymer—a main chain which is saturated, and which thus comprises a unit (I) of formula (I^{H}) repeated p times, a unit (II) of formula (II^{H}) repeated n times and, optionally, a unit (III) of formula (III^{H}) repeated m times.

The invention also relates to an adhesive composition comprising a copolymer P according to the invention and from 0.01% to 3% by weight, preferably from 0.1% to 1% by weight, of a crosslinking catalyst. Said adhesive composition is advantageously in the form of a viscous liquid.

The crosslinking catalyst that may be used in the composition according to the invention may be any catalyst known to a person skilled in the art for the condensation of silanols. Examples of such catalysts that may be mentioned include:
organotitanium derivatives, such as titanium(IV) diisopropoxide bis(acetylacetonate) (available commercially under the name Tyzor® AA75 from the company Dupont);
organoaluminum derivatives, such as the aluminum chelate available commercially under the name K-KAT® 5218 from the company King Industries;
organotin derivatives, such as dibutyltin dilaurate (DBTL); and
amines, such as 1,8-diazabicyclo[5.4.0]undec-7-ene (DBU) and 1,5-diazabicyclo[4.3.0]non-5-ene (DBN).

It is also possible to include, in the composition according to the invention, UV stabilizers, such as amines, or antioxidants.

The antioxidants may comprise primary antioxidants, which trap free radicals and which are generally substituted phenols, such as Irganox® 1010 from Ciba. The primary antioxidants may be used alone or in combination with other antioxidants, such as phosphites, for example Irgafos® 168 from Ciba.

According to a particularly preferred embodiment, the adhesive composition according to the invention is packaged in an airtight packaging prior to its final use, so as to protect it from ambient moisture. Such packaging may advantageously be formed of a multilayer sheet which typically comprises at least one aluminum layer and/or at least one high-density polyethylene layer. For example, the packaging is formed of a layer of polyethylene coated with a sheet of aluminum. Such packaging may in particular take the form of a cylindrical cartridge.

Finally, the invention relates to a process for assembling two substrates by bonding, comprising:
the coating of an adhesive composition as defined previously, preferably in the form of a layer with a thickness in a range from 0.3 to 5 mm, preferably from 1 to 3 mm, on at least one of the two surfaces which respectively belong to the two substrates to be assembled and which are intended to be brought into contact with each other along a faying surface; then
actually bringing the two substrates into contact along their faying surface.

Needless to say, the coating operation and the contacting operation have to be performed within a compatible time interval, as is well known to those skilled in the art, i.e. before the adhesive layer applied to the substrate loses its ability to attach, by adhesive bonding, this substrate to another substrate. In general, the crosslinking of the copolymer of the adhesive composition, in the presence of the catalyst and of the water of the ambient medium and/or of the water provided by at least one of the substrates, begins to take place during the coating operation and then continues to take place during the step in which the two substrates are brought into contact. In practice, the water generally originates from the relative humidity of the air.

The appropriate substrates are, for example, inorganic substrates, such as glass, ceramics, concrete, metals or alloys (such as aluminum alloys, steel, non-ferrous metals and galvanized metals); or else organic substrates, such as wood, plastics, such as PVC, polycarbonate, PMMA, polyethylene, polypropylene, polyesters or epoxy resins; substrates made of metal and composites coated with paint (as in the motor vehicle field).

The examples that follow are given purely by way of illustration of the invention and should not be interpreted in order to limit the scope thereof.

The copolymers P illustrated have a Brookfield viscosity at 23° C. of less than 50 Pa·s.

### EXAMPLE 1

### Depolymerization/Cyclization by Heating a Liquid poly(butadiene-isoprene), Followed by a Hot Cross-Metathesis in the Presence of CTA¹

Kuraprene® LIR-390 as defined previously is used as liquid poly(butadiene-isoprene), and, as chain-transfer agent, the CTA¹ having the formula:

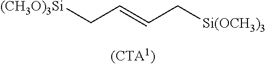

Step (i):

Poly(butadiene-isoprene) (81.00 mmol) and dry CH₂Cl₂ (9 ml) are introduced into a 20 ml round-bottomed flask in which was also placed a Teflon®-coated magnetic stirring bar. The flask and its contents are subsequently placed under argon.

The catalyst G2 defined previously (9.6 μmol) dissolved in CH₂Cl₂ (2 ml) is then added using a cannula.

This mixture is heated in an oil bath for 3 hours at 40° C. with stirring until the Kuraprene® LIR-390 has disappeared and a mixture of macrocyclic cooligomers O has formed, as attested to by size exclusion chromatography.

Step (ii):

The compound CTA¹ (0.27 mmol) is added by syringe and with stirring to the mixture contained in the flask from step (i) and heating is continued at a temperature of 40° C.

The ratio r, as defined previously, is: 0.27/81.00, i.e. 0.003

After 8 hours, with effect from the addition of the CTA¹, the product present in the flask is extracted after evaporation of the solvent under vacuum. This product is then recovered in the form of a colorless liquid, after precipitating from methanol, filtering and drying at 23° C. under vacuum.

Analysis by 1H/13C NMR gives the following results:

¹H NMR (CDCl₃, 500 MHz, 298 K): δ (ppm) repeating unit 2.10 (4H*n), 5.43 (2H*n), end group=1.63 (4H, m, ═CH—CH₂—Si—), 3.57 (18H, s, —Si—O—CH₃), 5.43 (2H, m, —CH═CH—CH₂—SH, 5.48 (2H, m, —CH═CH—CH₂—Si—).

¹³C NMR (CDCl₃, 100 MHz, 298 K): δ (ppm) repeating unit 27.4, 32.7, 131.4, end group=cis 10.9 (═CH—CH₂—Si—), trans 15.0 (═CH—CH₂—Si—), 50.7 (—Si—O—CH₃), 122.6 (—CH═CH—CH₂—SH, 131.4 (—CH═CH—CH₂—Si—).

These values confirm that the product obtained is a copolymer comprising two alkoxysilane end groups, the main chain of which essentially consists:
of unit (I) of formula:

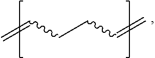

and
of unit (II) of formula:

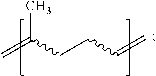

and
of which two units (I) are each connected to one of the two end groups of formula:

—CH₂—Si(OCH₃)₃

The number-average molecular mass Mn and the polydispersity index are respectively 17 000 g/mol and 2.7.

### EXAMPLE 2

### Depolymerization/Cyclization by Heating a Liquid poly(butadiene-isoprene), Followed by a Hot Cross-Metathesis in the Presence of CTA²

Example 1 is repeated, replacing, as chain-transfer agent, CTA¹ with CTA² of formula:

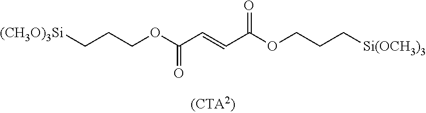

A polymer is also recovered in the form of a colorless liquid, the ¹H NMR/¹³C NMR analysis of which gives the following values:

¹H NMR (CDCl₃, 500 MHz, 298 K): δ (ppm) repeating unit 2.10 (4H*n), 5.43 (2H*n), end group=0.67 (4H, m, —CH₂—CH₂—CH₂—Si—), 1.45 (4H, m, —OOC—CH═CH—CH₂—CH₂—), 1.77 (4H, m, —COO—CH₂—CH₂—CH₂—Si—), 2.19 (4H, m, —OOC—CH═CH—CH₂—CH₂—), 3.57 (18H, s, —Si—O—CH₃), 4.09 (4H, t, —COO—CH₂—CH₂—CH₂—Si—), 5.81 (2H, m, —CH═CH—COO—), 6.94 (2H, m, —CH₂—CH═CH—COO—).

¹³C NMR (CDCl₃, 100 MHz, 298 K): δ (ppm) repeating unit 27.4, 32.7, 131.4, end group=5.5 (—COO—CH₂—CH₂—CH₂—Si—), 22.2 (—COO—CH₂—CH₂—CH₂—Si—), 66.2 (—COO—CH₂—CH₂—CH₂—SH, 50.7 (—Si—O—CH₃), 121.3 (—CH═CH—COO—), 149.6 (—CH═CH—CO—O—), 166.9 (—COO—).

These values confirm that the product obtained is a copolymer comprising two alkoxysilane end groups, the main chain of which essentially consists:
of unit (I) of formula:

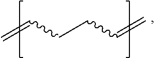

and
of unit (II) of formula:

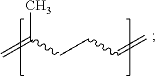

and

of which two units (I) are each connected to one of the two end groups of formula:

—C(O)O—(CH₂)₃—Si(OCH₃)₃

The number-average molecular mass Mn and the polydispersity index are, respectively, 22 700 g/mol and 2.80.

### EXAMPLE 3

### Depolymerization/Cyclization by Heating a poly(butadiene-isoprene) in the Presence of Norbornene, Followed by Cross-Metathesis in the Presence of CTA²

Example 2 is repeated, the 81.00 mmol of poly(butadiene-isoprene) being replaced in step (i) with a mixture of 41.00 mmol of poly(butadiene-isoprene) and of 40.00 mmol of norbornene, of formula:

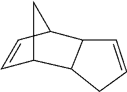

available from the company Sigma-Aldrich.

A polymer that is liquid at room temperature is also recovered, NMR analysis of which gives the following values:

¹H NMR (CDCl₃, 500 MHz, 298 K): δ (ppm) repeating unit trans: 1.08 (2H*n), 1.39 (4H*n), 2.07 (4H*n), 2.47 (2H*n trans), 5.24-5.44 (4H*n trans), cis: 1.82-1.91 (6H*n), 2.07 (4H*n), 2.82 (2H*n cis), 5.24-5.44 (4H*n cis), end group=0.67 (4H, m, —CH₂—CH₂—CH₂—Si—), 1.45 (4H, m, —OOC—CH═CH—CH₂—CH₂—), 1.77 (4H, m, —COO—CH₂—CH₂—CH₂—Si—), 2.19 (4H, m, —OOC—CH═CH—CH₂—CH₂—), 3.57 (18H, s, —Si—O—CH₃), 4.09 (4H, t, —COO—CH₂—CH₂—CH₂—Si—), 5.81 (2H, m, —CH═CH—COO—), 6.94 (2H, m, —CH₂—CH═CH—COO—).

¹³C NMR (CDCl₃, 100 MHz, 298 K): δ (ppm) repeating unit: 27.4, 33.1, 42.1, 43.4, 130.3, 133.1, end group=5.5 (—COO—CH₂—CH₂—CH₂—Si—), 22.2 (—COO—CH₂—CH₂—CH₂—Si—), 66.2 (—COO—CH₂—CH₂—CH₂—Si—), 50.7 (—Si—O—CH₃), 121.3 (—CH═CH—COO—), 149.6 (—CH═CH—CO—O—), 166.9 (—COO—)

These values confirm that the polymer obtained is a copolymer comprising two alkoxysilane end groups, the main chain of which essentially consists:
of unit (I) of formula:

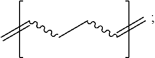

of unit (II) of formula:

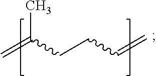

and
of unit (III) of formula:

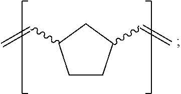

and
of which two units (I) are each connected to one of the two end groups of formula:

—C(O)O—(CH₂)₃—Si(OCH₃)₃

The number-average molecular mass Mn and the polydispersity index are, respectively, 22 600 g/mol and 2.80.

### EXAMPLE 4

### Depolymerization/Cyclization by Heating a Liquid poly(butadiene-isoprene) in the Presence of Dicyclopentadiene, Followed by Hot Cross-Metathesis in the Presence of CTA¹

Example 3 is repeated, replacing:
the norbornene with dicyclopentadiene, of formula:

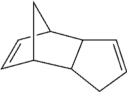

available from the company Sigma-Aldrich, and
the CTA² with CTA¹.

A polymer that is liquid at room temperature is also recovered, NMR analysis of which gives the following values:

¹H NMR (CDCl₃, 500 MHz, 298 K): δ (ppm) repeating unit 1.24 (1H*n), 1.59 (1H*n), 2.07 (4H*n), 2.26 (2H*n), 2.62 (1H*n), 2.85 (2H*n), 3.24 (1H*n), 5.36-5.68 (4H*n), end group=1.63 (4H, m, ═CH—CH₂—Si—), 3.57 (18H, s, —Si—O—CH₃), 5.43 (2H, m, —CH═CH—CH₂—Si—), 5.48 (2H, m, —CH═CH—CH₂—Si—).

¹³C NMR (CDCl₃, 100 MHz, 298 K): δ (ppm) repeating unit 27.4, 33.1, 35.1, 38.0, 42.3, 46.0, 47.1, 55.4, 130.5, end group=cis 10.9 (═CH—CH₂—Si—), trans 15.0 (═CH—CH₂—Si—), 50.7 (—Si—O—CH₃), 122.6 (—CH═CH—CH₂—Si—), 131.4 (—CH═CH—CH₂—Si—).

These values confirm that the polymer obtained is a copolymer comprising two alkoxysilane end groups, the main chain of which essentially consists:
of unit (I) of formula:

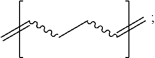

of unit (II) of formula:

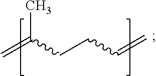

and
of unit (III) of formula:

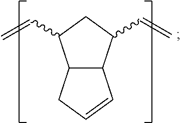

and
of which two units (I) are each connected to one of the two end groups of formula:

—CH₂—Si(OCH₃)₃

The number-average molecular mass Mn and the polydispersity index are, respectively, 28 300 g/mol and 2.80.

### EXAMPLE 5

### Preparation of an Adhesive Composition Comprising the Copolymer of Example 1

An adhesive composition consisting of 0.2% by weight of a crosslinking catalyst consisting of dioctyltin dineodecanoate (TIB KAT® 223 product from the company TIB Chemicals) and 99.8% by weight of copolymer according to the invention obtained in example 1 is prepared by simple mixing.

The mixture thus obtained is left under reduced pressure (20 mbar, i.e. 2000 Pa) for 15 minutes and then packaged in an aluminum cartridge.

The measurement of the tensile strength and the elongation at break by a tensile test was performed according to the protocol described below.

The principle of the measurement consists in:
drawing in a tensile testing machine, the mobile jaw of which moves at a constant speed equal to 100 mm/minute, a standard test specimen consisting of the crosslinked adhesive composition, and then
recording, at the moment at which the test specimen breaks, the applied tensile stress (expressed in MPa) and also the elongation of the test specimen (expressed as a percentage).

The standard test specimen is dumbbell-shaped, as illustrated in the international standard ISO 37. The narrow part of the dumbbell used has a length of 20 mm, a width of 4 mm and a thickness of 500 μm.

To prepare the dumbbell, the conditioned composition as described previously is heated to 100° C. and the amount necessary to form, on an A4 sheet of silicone-treated paper, a film having a thickness of 300 pm is then extruded over this sheet, which film is left at 23° C. and 50% relative humidity for 7 days for crosslinking. The dumbbell is then obtained by simply cutting it out from the crosslinked film.

A tensile stress of greater than 0.7 MPa and an elongation at break of greater than 200% are thus measured for said adhesive composition.

Said adhesive composition is also subjected to tests of bonding of two wooden panels (each measuring 20 mm×20 mm×2 mm) to give, after crosslinking for seven days at 23° C. and formation of an adhesive seal 1 mm thick over an area of 12.5 mm×20 mm, a braking stress of greater than 2 MPa in adhesive failure.

1. A hydrocarbon-based copolymer P comprising two alkoxysilane end groups F¹ and F² connected, respectively, to each of the two ends of the main chain, having the formulae:
—F¹: (R′O)₃₋ₜRₜSi—(CH₂)_{g1}—
and F²: —(CH₂)_{d1}—SiRₜ(OR′)₃₋ₜ; or else
—F¹: (R′O)₃₋ₜRₜSi—R″—O(O)C—(CH₂)_{g2}—
and F²: —(CH₂)_{d2}—C(O)O—R″—SiRₜ(OR′)₃₋ₜ;
in which:
t is an integer equal to 0, 1 or 2;
g1 and d1, which may be identical or different, represent an integer equal to 1, 2 or 3;
g2 and d2, which may be identical or different, represent an integer equal to 0, 1, 2 or 3;
R and R′, which may be identical or different, represent an alkyl radical comprising from 1 to 4 carbon atoms;
R″ is an alkylene radical comprising from 1 to 4 carbon atoms;
characterized in that the main chain of the copolymer P comprises:
a unit (I) of formula (I) repeated p times, p being an integer other than 0: 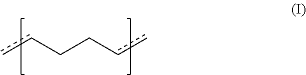
a unit (II) of formula (II) repeated n times, n being an integer other than 0: 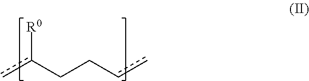
in which R⁰ represents a methyl radical or one of the three radicals having the following formula: 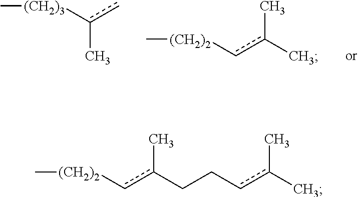
and, optionally, a unit (III) of formula (III) repeated m times, m being an integer greater than or equal to 0: 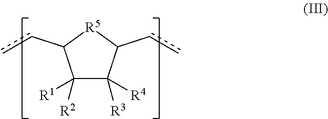
in which:
R¹, R², R³ and R⁴, which may be identical or different, represent:
a hydrogen or halogen atom; or
a radical comprising from 1 to 22 carbon atoms which is chosen from alkyl, alkenyl, alkoxycarbonyl, alkenyloxycarbonyl, alkylcarbonyloxy, alkenylcarbonyloxy and alkylcarbonyloxyalkyl, it being possible for the hydrocarbon-based chain of said radical to be optionally interrupted with at least one oxygen atom or one sulfur atom; in addition:
at least one of the groups R¹ to R⁴ can form, with at least one other of the groups R¹ to R⁴ and with the carbon atom or atoms to which said groups are linked, a 3- to 10-membered, optionally substituted, saturated or unsaturated hydrocarbon-based ring or heterocycle; and
at least one of the pairs (R¹, R²) and (R³, R⁴) can form, with the carbon atom to which said pair is linked, a group of two carbon atoms linked by a double bond: C═C, the other carbon atom of which bears two substituents chosen from a hydrogen atom and a C₁-C₄ alkyl radical; and
the carbon atom bearing one of the groups of the pair (R¹, R²) may be linked to the carbon atom bearing one of the groups of the pair (R³, R⁴) by a double bond, it being understood that, in accordance with the valency rules, only one of the groups of each of these two pairs is then present;
R⁵ represents:
an oxygen or sulfur atom, or
a divalent radical —CH₂—, —C(═O)— or —NR⁶— in which R⁶ is an alkyl or alkenyl radical comprising from 1 to 22 carbon atoms;
it also being pointed out that:
the bond [symbol] represents a single bond or a double bond;
F¹ and F² are directly linked to two units (I); and
n, p and m are such that the number-average molecular mass Mn of the copolymer P is within a range extending from 400 to 100 000 g/mol and its polydispersity index is within a range extending from 1.5 to 3.0.

2. The copolymer P as claimed in claim 1, characterized in that its main chain essentially consists of the repeating unit (I) of formula (I), of the repeating unit (II) of formula (II) and, optionally, of the repeating unit (III) of formula (III).

3. The copolymer P as claimed in claim 1, characterized in that the number p of units (I) and the number n of units (II) are such that:
p/(n+p) is between 45% and 95%, and
n/(n+p) is between 5% and 55%.

4. The copolymer P as claimed in claim 1, characterized in that its main chain is such that:
the unit (I) also has the formula (I′): 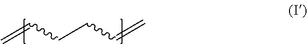
the unit (II) also has the formula (II′): 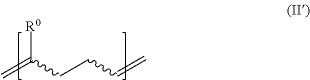
in which R⁰ represents a methyl radical or one of the three radicals having the following formula: 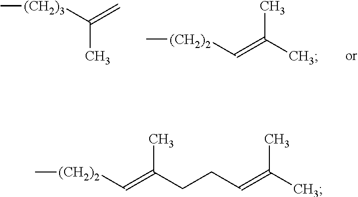
and, optionally, the unit (III) also has the formula (III′): 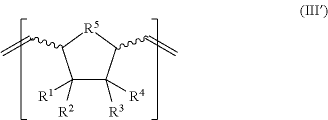
it being pointed out that, in the above formulae, the [symbol] bond is a single bond geometrically oriented on one side or the other relative to the double bond (cis or trans).

5. The copolymer P as claimed in claim 4, characterized in that its main chain is such that:
on the p units of formula (I′), p″ also correspond to formula (I″), p″ being an integer other than 0, less than p and such that p″/p is greater than 0.8: 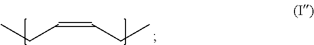
and
on the n units of formula (II′), n″ also correspond to formula (II″), n″ being an integer other than 0, less than n and such that n″/n is greater than 0.9:

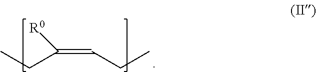

6. The copolymer P as claimed in claim 1, characterized in that its main chain is such that:
the unit (I) also has the formula (I^{H}): 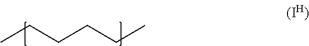
the unit (II) also has the formula (II^{H}): 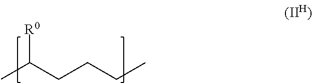
in which R⁰ represents a methyl radical or one of the three radicals having the following formula: 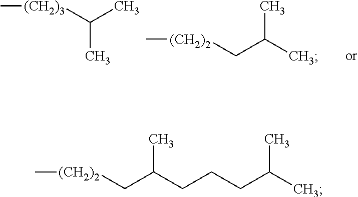
and, optionally, the unit (III) has the formula (III^{H}):

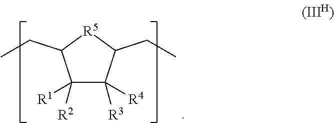

7. The copolymer P as claimed in claim 1, characterized in that the radical R⁰ of the unit (II) represents a methyl radical.

8. The copolymer P as claimed in claim 1, characterized in that F¹ is (R′O)₃₋ₜRₜSi—(CH₂)_{g1}— and F² is —(CH₂)_{d1}—SiRₜ(OR′)₃₋ₜ, with g1=d1=1.

9. Copolymer P according to claim 1, characterized in that F¹ is: (R′O)₃₋ₜRₜSi—R″—O(O)C—(CH₂)_{g2}— and F² is:
—(CH₂)_{d2}—C(O)O—R″—SiRₜ(OR′)₃₋ₜ, with g2=d2=0.

10. A process for preparing the hydrocarbon-based copolymer P as defined in claim 1, said process comprising:
(i) a step of heating at a temperature ranging from 30° C. to 80° C.:
(a) of a statistical bipolymer A chosen from a poly(butadiene-isoprene), a poly(butadiene-myrcene) and a poly(butadiene-farnesene); and
(b) optionally a compound B of formula (B): 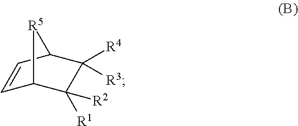
and then
(ii) a step of heating the product formed in step (i) to a temperature in an interval from 20 to 60° C., in the presence of a chain-transfer agent of formula (C): 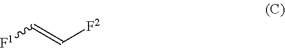
in which:
F¹ and F² are as defined previously;
the [symbol] bond is a single bond geometrically oriented on one side or the other relative to the double bond (cis or trans);
it also being pointed out that each of the steps (i) and (ii) is performed in the presence of a metathesis catalyst and of a solvent.

11. The process as claimed in claim 10, characterized in that step (i) leads to the formation of a macrocyclic cooligomer O comprising:
the unit of formula (I′) repeated p′⁰ times, p′⁰ being an integer other than 0;
the unit of formula (II′) repeated n′⁰ times, n′⁰ being an integer other than 0;
and, optionally, the unit of formula (III′) repeated m′⁰ times, m′⁰ being an integer greater than or equal to 0;
it being pointed out that p′⁰, n′⁰ and m′⁰ are such that the number-average molecular mass Mn of the cyclic cooligomer O is in a range extending from 162 to 5000 g/mol, preferably from 162 to 2000 g/mol.

12. The process as claimed in claim 10, characterized in that the bipolymer A used in step (i) is a poly-(butadiene-isoprene), preferably comprising from 45% to 95% by number of butadiene-based units and from 5% to 55% by number of isoprene-based units, said percentages being expressed on the basis of the total number of constituent units of the poly(butadiene-isoprene) chain.

13. The process as claimed in claim 12, characterized in that the chain of the poly(butadiene-isoprene) used in step (i) comprises:
less than 5% by number of vinyl-1,2 butadiene units on the basis of the number of butadiene-based units, and
less than 5% of the total number of vinyl-1,2 isoprene units and of vinyl-3,4 isoprene units on the basis of the number of isoprene-based units.

14. The process as claimed in claim 12, characterized in that the chain of the poly(butadiene-isoprene) used in step (i) comprises:
at least 80% by number of cis-1,4 butadiene units on the basis of the number of butadiene-based units, and
at least 90% by number of cis-1,4 isoprene units on the basis of the number of isoprene-based units.

15. The process as claimed in claim 10, characterized in that the molar amount of CTA to be introduced into step (ii), the molar amount of bipolymer A and, optionally, the molar amount of compound B introduced into step (i) are such that the ratio r which is equal to the ratio of the number of moles of said CTA:
to the number N_{(A)} of moles of the bipolymer A, in the case where said bipolymer A is the only reagent used in step (i), or
to the sum of N_{(A)} and of the number of moles N_{(B)} of the compound of formula (B), in the case where the compound of formula (B) is also used in step (i), is in an interval ranging from 0.0010 to 1.0.

16. An adhesive composition comprising a copolymer P as defined in claim 1 and from 0.01% to 3% by weight of a crosslinking catalyst.

17. A process for assembling two substrates by bonding, comprising:
the coating of an adhesive composition as defined in claim 16, preferably in the form of a layer with a thickness in a range from 0.3 to 5 mm, on at least one of the two surfaces which respectively belong to the two substrates to be assembled and which are intended to be brought into contact with each other along a faying surface; and then
actually bringing the two substrates into contact along their faying surface.
